(19) United States
(12) Patent Application Publication
(10) Pub. No.: US 2024/0318008 A1
(43) Pub. Date: Sep. 26, 2024

(54) LIDAR REFLECTIVE MULTILAYER COATINGS WITH HIGH FLOP INDEX

(71) Applicant: BASF COATINGS GMBH, Muenster (DE)

(72) Inventors: Manoj KAYARKATTE, Mangalore (IN); Rajkumar JANA, Mangalore (IN); Qingling ZHANG, Southfield, MI (US); Zenon Paul CZORNIJ, Southfield, MI (US); Donald H. CAMPBELL, Hartland, MI (US)

(21) Appl. No.: 18/579,169

(22) PCT Filed: Aug. 30, 2022
(86) PCT No.: PCT/EP2022/074115

§ 371 Date: Jan. 12, 2024

(30) Foreign Application Priority Data
Aug. 30, 2021 (IN) 202141039185
May 16, 2022 (EP) 22173578.0

(51) Int. Cl. C09D 5/33; C09D 5/00; C09D 5/36; C09D 7/40; C09D 7/41; C09D 7/62

(52) U.S. Cl. CPC C09D 5/004; C09D 5/002; C09D 5/36; C09D 7/41; C09D 7/62; C09D 7/70

(57) ABSTRACT

The present invention relates to Disclosed herein is a multilayer coating system being present on an optionally pre-coated substrate and including at least three coatings layers L1, L2 and L3 being different from one another, the first layer L1 applied on an optionally pre-coated substrate, the second layer L2 applied over L1, and the third top coating layer L3 applied over L2, where layer L1 is formed from a primer coating composition and layer L2 is formed from a basecoat composition different from the primer coating composition, where the primer coating composition is free of or essentially free of metal effect pigments. Further disclosed herein are a method of preparing the multilayer coating system, a kit-of-parts and a method of using the kit-of-parts for improving the LiDAR reflectivity, measured at an angle of incidence of 0°, and the flop index, of multilayer coating systems.

The present invention relates to a multilayer coating system being present on an optionally pre-coated substrate and comprising at least three coatings layers L1, L2 and L3 being different from one another, the first layer L1 applied an optionally pre-coated substrate, the second layer L2 applied over L1, and the third top coating layer L3 applied over L2, wherein layer L1 is formed from a primer coating composition and layer L2 is formed from a basecoat composition different from the primer coating composition, wherein the primer coating composition is free of or essentially free of metal effect pigments, but inter alia comprises a pigment mixture P-C comprising at least two kinds of pigments, namely at least one organic black or inorganic black pigment P-C1, which is not a carbon black pigment, and which is transparent or substantially transparent to NIR-radiation or which is reflective or substantially reflective to NIR-radiation, and at least one inorganic white pigment P-C2, which is reflective or substantially reflective to NIR-radiation, and wherein the basecoat composition inter alia comprises at least one pearlescent or interference pigment B-C1, which is present in an amount that exceeds the amount of any aluminum metal effect pigment(s) B-C2 optionally also present therein, a method for its production, a kit-of-parts and a use of said kit-of-parts for improving the LiDAR reflectivity, measured at an angle of incidence of 0°, and the flop index, of multilayer coating systems.

### BACKGROUND OF THE INVENTION

Recent advances have been made in technologies related to self-driving vehicles and vehicles with ADAS (Advanced Driver Assistance Systems). Vehicles with ADAS decrease driving stress, decrease the number of accidents, improve fuel economy etc. ADAS rely highly rely on remote sensing technologies on optical or electromagnetic means for position and speed determination.

LiDAR (Light Detection And Ranging) is a remote-sensing technology that can be deployed within such vehicles as the primary source of object recognition. By illuminating the surrounding environment with Laser light (typically 905 nm or 1550 nm) LiDAR maps distance to objects in its path in real-time by measuring the reflection with a sensor and can be paired with software to safely react to objects within their vicinity. For example, if an object gets too close to the vehicle, the software can react to avoid collision with the object. Since LiDAR utilizes near-infrared light (near-IR light or NIR light) as its source of illumination, the technology has to overcome several challenges. Although many light-colored objects reflect this type of light with relative ease, especially dark colored and clear objects either absorb or pass the light, thus lowering the resolution and leading to potential instances, where objects are not sufficiently observed by the LiDAR and avoided by vehicles equipped with such systems.

Apart from the LiDAR instrument as such, one of the important factors for the accuracy of the measurement is the surface of the illuminated object. In case of automobiles and other vehicles, the surface is usually covered by a multilayer coating, which plays an important role in determining the LiDAR reflectivity. An object's ability to reflect light is dependent on its bulk and its surface properties, and manifests itself as specular or diffuse. Specular reflection of light occurs when incident light stemming from a light source in a single direction is reflected into a single outgoing direction at the opposite angle to the plane normal to the reflective surface as the incident wave. Diffuse reflection occurs when incident light stemming from a light source in a single direction is reflected at many angles. In theory, both specular and diffuse reflection can be utilized in LiDAR technology for vehicles, but in practice, this is much more difficult. With specular reflection, much of the luminance is observed at the angle opposite the angle of incidence. Thus, for a moving vehicle with a detector positioned at the light source, this could prove problematic if the angle of incidence was positioned away from the tandem light source and detector. Such is the case when the angle of incidence is 45 degrees or higher from the plane normal to the reflective surface. In contrast, diffuse reflection demonstrates equivalent luminance from all directions, which can alleviate this concern, and allows detection at all angles.

Still, most of the current coatings are applied to substrates such as vehicle bodies for improved durability and aesthetics, but usually impart no sufficient functionality in reflecting near-IR light for the purposes of greater visibility to LiDAR technology.

The coating layers on vehicle bodies and parts thereof, starting from the substrate in this order, in OEM are typically a conversion coating layer, an electrodeposition coating layer, such as a cathodic electrodeposition layer, a primer layer (also sometimes referred to as filler layer), at least one basecoat layer, and on top of the basecoat layer a clearcoat layer as top coat. A typical OEM multilayer coating layer thus comprises a primer, at least one basecoat and a clearcoat. The clearcoat layer is a visibly transparent layer and is usually also transparent to IR radiations. U.S. Pat. No. 8,679,617 B2 discloses a solar reflective coating system comprising inter alia a first and a second coating layer, which is present underneath the first coating layer. The second layer comprises a visibly absorbing infrared transparent pigment as well as a thin flake metal or metal alloy infrared reflective pigment. Using such a thin flake metal or metal alloy pigment, i.e., a metal effect pigment, in the second layer, however, is disadvantageous since, due to its presence, an undesired high angle dependency in LiDAR application results: the LiDAR reflectivity of such a coating layer at an angle of incidence of 45° is typically below 9% or even much lower such as below 5%.

In recent years some approaches were developed to improve the LiDAR reflectivity of multilayer coatings, particularly those applied to vehicles. In a first approach, NIR-reflective pigments are contained in the basecoat layer. The NIR light passes the non-NIR-absorbing (NIR-transparent) protective clearcoat layer and is reflected by NIR-reflective pigment(s) in the basecoat layer. However, the basecoat layer is usually the layer, which determines the color and/or effect characteristics of the multilayer automotive coatings. Therefore, basecoats usually contain organic pigments and effect pigments such as metal flakes. These flake pigments, however, are transparent in the near-infrared (NIR) region. Thus, in a different, second approach, the NIR light passes the non-NIR-absorbing protective clearcoat layer and also the basecoat layer containing non-NIR-absorbing coloring and/or effect pigments, but must then be reflected by the primer layer. Due to the transparency at NIR of the aforementioned pigments within the basecoat, the NIR reflectivity of the primer plays a pivotal role in determining the reflectivity of such systems. While bright primers are in general NIR reflective, dark primers including ones containing carbon blacks as mentioned hereinbefore are usually NIR absorbing. However, the use of carbon black leads to undesired heat build-ups.

Further, problems in particular may arise when metal effect pigments are contained in the basecoat layer to provide the multilayer coating with a so-called lightness flop effect, particularly, if the lightness flop is to be provided in form of a silver-metallic multilayer coating. The term “lightness flop” (or just flop as used herein) refers to the difference between the amount or hue of light reflected at different angles from a metallic coating surface. The flop inter alia depends on particle size and distribution, particle shape and orientation of the effect pigment particles in the coating layer. The extend of the flop effect can be expressed by the so-called flop index, which is a measure of change in reflectance of a metallic coating containing platelet-shaped pigments as it is rotated through the range of viewing angles. A flop index of 0 indicates a solid color, while a very high flop may even result in a flop index of above 15. Generally, larger platelet-shaped particles are better reflectors leading to higher flop index and brightness, while smaller particles show less flop as the amount of light scattered at edges increases as a nondirectional reflection. With even coarser metallic pigments, the individual particles become more visible, leading to graininess or texture. Thus, although the most desired platelet-shaped metallic pigments are typically highly reflective and coatings obtained by using such pigments typically possess a high flop index, they also possess a very specular reflectivity and therefore have low reflectivity in the off-specular angle range, which adversely affects the LiDAR reflectivity from those vehicles which are not directly in front of the light source/detector system, but at an angle or in adjacent lane thereto.

Consequently, coatings obtained by use of conventional metallic pigment containing coating compositions show a rather high flop index of 9 and above, while their LiDAR reflectivity at an angle of incidence of 45° is typically below 9% or even much lower such as below 5%. Generally, the higher the flop is, the lower is the LiDAR reflectivity.

Thus, there is a need to provide multilayer coating systems for use in the automotive industry, which are able to preserve the lightness flop at a level being about the same as for conventional metallic coatings, in particular silver-metallic coatings, while at the same time exhibit an improved visibility to LiDAR detection, i.e., a high LiDAR reflectivity, as well as an excellent appearance particularly including the color effect provided by the primer layer of such a multilayer coating system.

### Problem

It has been therefore an object underlying the present invention to provide a multilayer coating system for use in the automotive industry, which is able to preserve the lightness flop at a level being about the same as for conventional metallic coatings, in particular silver-metallic coatings, which at the same time exhibits an improved visibility to LiDAR detection, i.e., a high LiDAR reflectivity, as well as an excellent appearance particularly including the color effect provided by the primer layer of such a multilayer coating system.

### Solution

This object has been solved by the subject-matter of the claims of the present application as well as by the preferred embodiments thereof disclosed in this specification, i.e., by the subject matter described herein.

A first subject-matter of the present invention is a multilayer coating system being present on an optionally pre-coated substrate and comprising at least three coatings layers L1, L2 and L3 being different from one another, namely
a first coating layer L1 applied over at least a portion of an optionally pre-coated substrate,
a second coating layer L2 applied over the first coating layer L1, and
a third top coating layer L3 applied over the second coating layer L2,
wherein the first coating layer L1 is formed from a primer coating composition and the second coating layer L2 is formed from a basecoat composition different from the primer coating composition,
characterized in that
the primer coating composition comprises as at least one constituent P-A at least one film-forming polymer P-A1, and in case of P-A1 being externally crosslinkable, at least one crosslinking agent P-A2, water and/or one or more organic solvents as constituent(s) P-B, and is free of or essentially free of metal effect pigments, but comprises a pigment mixture as at least one constituent P-C comprising at least two kinds of pigments being different from one another, namely at least one organic black or inorganic black pigment P-C1, which is not a carbon black pigment, and which is transparent or substantially transparent to NIR-radiation or which is reflective or substantially reflective to NIR-radiation, and at least one inorganic white pigment P-C2, which is reflective or substantially reflective to NIR-radiation,
wherein pigment P-C1 is present in the primer coating composition in an amount in a range of from 0.1 to 20.0 wt.-%, based on the total weight of the primer coating composition, and pigment P-C2 is present in the primer coating composition in an amount in a range from 0.2 to 40.0 wt.-%, based on the total weight of the primer coating composition, and in that
the basecoat composition comprises as at least one constituent B-A at least one film-forming polymer B-A1, and in case of B-A1 being externally crosslinkable, at least one crosslinking agent B-A2, water and/or one or more organic solvents as constituent(s) B-B, and at least one effect pigment B-C1, which is a preferably platelet-shaped pearlescent or interference pigment, wherein the amount of the at least one pigment B-C1 in the basecoat composition exceeds the amount of any aluminum metal effect pigment(s) B-C2 optionally also present therein.

A further subject-matter of the present invention is a method for preparing the inventive multilayer coating system comprising at least steps (1), (2), (3) and (4), namely
(1) applying a primer coating composition to at least a portion of an optionally pre-coated substrate and forming a first coating film on at least a portion of the optionally pre-coated substrate,
(2) applying a basecoat composition different from the primer coating composition applied in step (1) to the first coating film present on the substrate obtained after step (1) and forming a second coating film, which preferably is adjacent to the first coating film,
(3) applying a coating composition different from the compositions applied in steps (1) and (2) to the second coating film present on the substrate obtained after step (2) and forming a third coating film, which is preferably adjacent to the second coating film, wherein said coating composition is preferably a clearcoat composition, and
(4) jointly curing at least the second and third coating films applied in steps (2) and (3) and optionally also the first coating film applied in step (1) in case said first coating film was not cured prior to performing of step (2) to obtain a multilayer coating system comprising at least the first, the second and the third coating layers L1, L2 and L3.

A further subject-matter of the present invention is a kit-of-parts comprising in spatially separated form
as part (A), a primer coating composition as defined hereinbefore and hereinafter usable for preparing the first coating layer L1 of a multilayer coating system as defined as defined hereinbefore and hereinafter, and
as part (B), a basecoat composition as defined hereinbefore and hereinafter usable for preparing the second coating layer L2 of a multilayer coating system as defined hereinbefore and hereinafter, and
optionally as part (C), a clearcoat composition as defined hereinbefore and hereinafter usable for preparing the third coating layer L3 of a multilayer coating system as defined hereinbefore and hereinafter.

A further subject-matter of the present invention is a use of the kit-of-parts for improving, in particular for increasing, the LiDAR reflectivity, measured at an angle of incidence of 45°, and the flop index of multilayer coating systems, preferably of the multilayer coating system as defined hereinbefore and hereinafter, preferably for improving, in particular for increasing, the LiDAR reflectivity of multilayer coating systems, more preferably of the multilayer coating system as defined hereinbefore and hereinafter, to at least 10%, preferably to at least 15%, and the flop index of multilayer coating systems, more preferably of a multilayer coating system as defined hereinbefore and hereinafter to 8, preferably to ≥9, more preferably to ≥10, even more preferably to ≥12.

It has been surprisingly found that the inventive multilayer coating system is able to preserve the lightness flop—induced in particular by the at least one preferably platelet-shaped pearlescent or interference pigment B-C1 and optionally further present aluminum metal effect pigment(s) present in the basecoat layer L2—at a level being about the same as for conventional metallic coatings, in particular silver-metallic coatings, but wherein the inventive multilayer coating system at the same time additionally exhibits an improved visibility to LiDAR detection, i.e., a high LiDAR reflectivity—in particular due to its primer layer L1—, as well as an excellent appearance particularly including the color effect provided by the primer layer the multilayer coating system.

In particular, it has been found that the inventive multilayer coating system provides both a high flop index and a high off-specular LiDAR reflectivity, in particular for a variety of different silver shades, i.e., allows the additional presence of suitable opaque aluminum metal effect pigments within the basecoat without impairing the LiDAR reflectivity of the multilayer coating system. Such aluminum effect pigments are used for providing suitable and desired silver shades, distinct color and a sparkling effect. Thus, a better flexibility for designing different silver shades is possible by making of the inventive multilayer coating system, in particular of OEM, without impairing the LiDAR reflectivity, in particular at angles of 45°.

It has been surprisingly found that in particular due to the presence of the primer layer L1, the inventive multilayer coating system has both a high IR reflectivity and a high NIR reflectivity, and thus a high LiDAR reflectivity. In particular, it has been found that a LiDAR reflectivity, measured at an angle of incidence (AOI) of 45°, of at least 10%, preferably to at least 15%, can be achieved for the inventive multilayer coating system. The primer layer L1 as such exhibits a LiDAR reflectivity, measured at an angle of incidence (AOI) of 0°, of at least 40%, preferably of at least 45%, more preferably of at least 50%, even more preferably of at least 55%, still more preferably of at least 60%, yet more preferably of at least 65%, in particular of at least 70%. LiDAR reflectivity is measured according to the method disclosed in the method section. It has been in particular surprisingly found that at the same time in particular due to the presence of the basecoat layer L2 and the pigment(s) present therein, the inventive multilayer coating system has a flop index of ≥8, preferably to ≥9, more preferably to ≥10, even more preferably to ≥12.

It has been further found that the inventive multilayer coating is able to prevent any undesired heat build-ups originating from any of its constituents present in any layers thereof such as carbon black, in particular when being part of a multilayer coating system as used in the automotive industry, as no or essentially no carbon black has to be used for providing any of the layers, in particular the primer layer L1. In particular, the primer coating composition used for preparation of L1 is free or essentially free of any carbon black pigments. Rather, the primer coating composition used for preparing L1 makes instead use or other suitable organic or inorganic black pigments, in particular perylene pigments such as Paliogen® black L0086.

### DETAILED DESCRIPTION OF THE INVENTION

The term “comprising” in the sense of the present invention, in connection for example with the primer coating composition and/or the basecoat composition, preferably has the meaning of “consisting of”. With regard, e.g., to the primer coating composition and/or the basecoat composition, it is possible—in addition to all mandatory constituents present therein—for one or more of the further optional constituents identified hereinafter to be also included therein. All constituents may in each case be present in their preferred embodiments as identified below.

The proportions and amounts in wt.-% (% by weight) of any of the constituents given hereinafter, which are present in each of the coating compositions such as the primer coating composition and/or the basecoat composition add up to 100 wt.-%, based in each case on the total weight of the coating composition such as the primer coating composition and/or the basecoat composition.

As used herein, the term “near-IR” or “near-infrared radiation or light” or “NIR” refers to electromagnetic radiation in the near-infrared range of the electromagnetic spectrum. Such near-IR electromagnetic radiation may have a wavelength from 800 nm to 2500 nm, such as from 850 to 2000 nm or such as from 900 nm to 1600 nm. In particular, the NIR light used has a wavelength from 880 nm to 930 nm with 905 nm as center wavelength. The near-IR electromagnetic radiation source that may be used in the present invention to produce NIR light includes, without limitation, light emitting diodes (LEDs), laser diodes or any light source that is capable of emitting electromagnetic radiation having a wavelength from 800 nm to 2500 nm (in the near-IR range). The near-IR electromagnetic radiation source may be used in a LiDAR system. The LiDAR system may utilize lasers to generate electromagnetic radiation with a wavelength from 900 nm to 1600 nm.

Preferably, the inventive multilayer coating system is able to reflect NIR light, preferably NIR light having a wavelength from 800 to 2500 nm. In particular, the first coating layer L1 is able to reflect NIR light, preferably NIR light having a wavelength from 800 to 2500 nm.

The term “pigment” is known to the skilled person, from DIN 55943 (date: October 2001), for example. A “pigment” in the sense of the present invention refers preferably to a constituent in powder or flake form which is substantially, preferably entirely, insoluble in the medium surrounding them, such as in one of the coating compositions, for example. Pigments are preferably colorants and/or substances which can be used as pigment on account of their magnetic, electrical and/or electromagnetic properties. Pigments differ from “fillers” such as barium sulfate preferably in their refractive index, which for pigments is ≥1.7. The term “filler” is known to the skilled person, from DIN 55943 (date: October 2001), for example. Pigments can be inorganic or organic.

Each of the coating compositions used in steps (1), (2), and (3) of the inventive method and/or used for preparing coating layers L1, L2 and L3 of the inventive multilayer coating system may contain—besides the constituents outlined in more detail hereinafter—one or more commonly used additives depending on the desired application. For example, each of the coating compositions may comprise independently of one another at least one additive selected from the group consisting of reactive diluents, catalysts, light stabilizers, antioxidants, deaerators, emulsifiers, slip additives, polymerization inhibitors, plasticizers, initiators for free-radical polymerizations, adhesion promoters, flow control agents, film-forming auxiliaries, sag control agents (SCAs), flame retardants, corrosion inhibitors, siccatives, thickeners, biocides and/or matting agents. They can be used in known and customary proportions. Preferably, their content, based on the total weight of each the coating composition is 0.01 to 20.0 wt.-%, more preferably 0.05 to 15.0 wt.-%, particularly preferably 0.1 to 10.0% By weight, most preferably from 0.1 to 7.5% by weight, especially from 0.1 to 5.0% by weight and most preferably from 0.1 to 2.5% by weight.

### Multilayer Coating System

A first subject-matter of the present invention is a multilayer coating system being present on an optionally pre-coated substrate and comprising at least three coatings layers L1, L2 and L3 being different from one another. Preferably, at least the second and the third coating layers L2 and L3 are positioned adjacently to each other. More preferably, also the first and the second coating layers L1 and L2 are positioned adjacently to each other.

Preferably, both the primer coating composition used to form the first coating layer L1 and the basecoat composition used to form the second coating layer L2 are free or essentially free of any carbon black. Preferably, also the topcoat composition used to form the third coating layer L3 free or essentially free of any carbon black. “Essentially free” means that no carbon black pigments are added on purpose and that preferably, their amount, if present is below 0.1 wt.-%, in particular below 0.01 wt.-%, most preferably below 0.001 wt.-%, based on the total weight of the respective coating composition.

Preferably, the multilayer coating system has a LiDAR reflectivity, measured at an angle of incidence of 0°, of at least 10%, more preferably of at least 15%, and a flop index of ≥8, more preferably of ≥9, even more preferably of ≥10, yet more preferably of ≥12.

Each of the coating compositions used in the inventive method, in particular in each of steps (1) to (3), which will be described hereinafter, and/or for preparing the multilayer coating system can be aqueous (waterborne) or organic solvent(s) based (solventborne, non-aqueous). Preferably, the topcoat, preferably clearcoat, composition is organic solvent(s) based (solventborne, non-aqueous). Preferably, the basecoat composition is aqueous or solventborne, more preferably aqueous. Preferably, the primer coating composition is aqueous or solventborne, more preferably aqueous.

The term “solventborne” or “non-aqueous” is understood preferably for the purposes of the present invention to mean that organic solvent(s), as solvent(s) and/or as diluent(s), is/are present as the main constituent of all solvents and/or diluents present in the respective coating composition such as in the primer coating composition if the respective coating composition is solventborne. Preferably, organic solvent(s) are present in an amount of at least 35 wt.-%, based on the total weight of the coating composition. A solventborne coating composition preferably includes an organic solvent(s) fraction of at least 40 wt.-%, more preferably of at least 45 wt.-%, very preferably of at least 50 wt.-%, based in each case on the total weight of the coating composition. All conventional organic solvents known to those skilled in the art can be used as organic solvents. The term “organic solvent” is known to those skilled in the art, in particular from Council Directive 1999/13/EC of 11 Mar. 1999. Examples of such organic solvents would include heterocyclic, aliphatic, or aromatic hydrocarbons, mono- or polyhydric alcohols, especially methanol and/or ethanol, ethers, esters, ketones, and amides, such as, for example, N-methylpyrrolidone, N-ethylpyrrolidone, dimethylformamide, toluene, xylene, butanol, ethyl glycol and butyl glycol and also their acetates, butyl diglycol, diethylene glycol dimethyl ether, cyclohexanone, methyl ethyl ketone, methyl isobutyl ketone, acetone, isophorone, or mixtures thereof. A solventborne coating composition preferably is free or essentially free of water. The term “essentially” in this context preferably means that no water is added on purpose when preparing the coating composition.

The term “waterborne” or “aqueous” is understood preferably for the purposes of the present invention to mean that water is present as the main constituent of all solvents and/or diluents present an aqueous coating composition such as in the primer coating composition. Preferably, water is present in an amount of at least 35 wt.-%, based on the total weight of the coating composition. An aqueous coating composition preferably includes a water fraction of at least 40 wt.-%, more preferably of at least 45 wt.-%, very preferably of at least 50 wt.-%, based in each case on the total weight of the coating composition. The fraction of organic solvent(s) is preferably <20 wt.-%, more preferably in a range of from 0 to <20 wt.-%, very preferably in a range of from 0.5 to 20 wt.-% or to 17.5 wt.-% or to 15 wt.-% or to 10 wt.-%, based in each case on the total weight of the coating composition.

The inventive multilayer coating system is particularly suitable as a coating of automotive vehicle bodies or parts thereof including respective metallic substrates, but also plastic substrates such as polymeric substrates. Consequently, the preferred substrates are automotive vehicle bodies or parts thereof.

Suitability as metallic substrates used in accordance with the invention are all substrates used customarily and known to the skilled person. The substrates used in accordance with the invention are preferably metallic substrates, more preferably selected from the group consisting of steel, preferably steel selected from the group consisting of bare steel, cold rolled steel (CRS), hot rolled steel, galvanized steel such as hot dip galvanized steel (HDG), alloy galvanized steel (such as, for example, Galvalume, Galvannealed or Galfan) and aluminized steel, aluminum and magnesium, and also Zn/Mg alloys and Zn/Ni alloys. Particularly suitable substrates are parts of vehicle bodies or complete bodies of automobiles for production.

Preferably, thermoplastic polymers are used as plastic substrates. Suitable polymers are poly(meth)acrylates including polymethyl(meth)acrylates, polybutyl (meth)acrylates, polyethylene terephthalates, polybutylene terephthalates, polyvinylidene fluorides, polyvinyl chlorides, polyesters, including polycarbonates and polyvinyl acetate, polyamides, polyolefins such as polyethylene, polypropylene, polystyrene, and also polybutadiene, polyacrylonitrile, polyacetal, polyacrylonitrile-ethylene-propylene-diene-styrene copolymers (A-EPDM), ASA (acrylonitrile-styrene-acrylic ester copolymers) and ABS (acrylonitrile-butadiene-styrene copolymers), polyetherimides, phenolic resins, urea resins, melamine resins, alkyd resins, epoxy resins, polyurethanes, including TPU, polyetherketones, polyphenylene sulfides, polyethers, polyvinyl alcohols, and mixtures thereof. Polycarbonates and poly(meth)acrylates are especially preferred.

The substrate used in accordance with the invention is preferably a metallic substrate pretreated with at least one metal phosphate such as zinc phosphate and/or pretreated with at least one an oxalate. A pretreatment of this kind by means of phosphating, which takes place normally after the substrate has been cleaned and before the substrate is electrodeposition-coated, is in particular a pretreatment step that is customary in the automobile industry.

### First Layer L1 and Primer Coating Composition

The first coating layer L1 of the multilayer coating system is applied over at least a portion of an optionally pre-coated substrate. The first coating layer L1 is formed from a primer coating composition.

The term “primer” or “primer coating composition” is known to a person skilled in the art. A primer typically is applied after the substrate has been provided with a cured electrodeposition coating layer. The cured electrodeposition coating film is present underneath and preferably adjacent to the cured primer coating film. Thus, a primer coating composition can be applied to an optionally pre-coated substrate and forming a primer coating film on the optionally pre-coated substrate. Then, an optional curing step of this primer coating film is possible before any further coating compositions are applied.

The primer coating composition can be aqueous (waterborne) or organic solvent(s) based (solventborne, non-aqueous). Preferably, it is aqueous.

The primer coating composition is free or essentially free of any metal effect pigments, in particular free or essentially free of any aluminum pigments. Preferably, the primer coating composition is free or essentially free of any effect pigments at all. The terms “effect pigment” and “metal effect pigment” are described hereinafter in more detail. “Essentially free” in this context preferably means that no metal effect pigment or effect pigment is added on purpose and that preferably, their amount, if present, is below 0.1 wt.-%, in particular below 0.01 wt.-%, most preferably below 0.001 wt.-%, based on the total weight of the primer coating composition.

The primer coating composition comprises as at least one constituent P-A at least one film-forming polymer P-A1, and in case of P-A1 being externally crosslinkable, at least one crosslinking agent P-A2, water and/or one or more organic solvents as constituent(s) P-B, and a pigment mixture as at least one constituent P-C comprising at least two kinds of pigments being different from one another, namely at least one organic black or inorganic black pigment P-C1, which is not a carbon black pigment, and which is transparent or substantially transparent to NIR-radiation or which is reflective or substantially reflective to NIR-radiation, and at least one inorganic white pigment P-C2, which is reflective or substantially reflective to NIR-radiation.

Preferably, the first coating layer L1 formed from the primer coating composition and applied over at least a portion of the optionally pre-coated substrate has a brightness value L* according to the CIELAB system at 45° of no more than 40, preferably of no more than 38, more preferably of no more than 35, even more preferably of no more than 30, and/or has a LiDAR reflectivity, measured at an angle of incidence of 0°, of at least 40%, preferably of at least 45%, more preferably of at least 50%, even more preferably of at least 55%, still more preferably of at least 60%, yet more preferably of at least 65%, in particular of at least 70%.

Preferably, the first coating layer L1 is obtained from applying the primer coating composition and from curing the resulting primer coating film to obtain the first coating layer L1. Preferably, curing takes place at about 140° C. for 25 minutes.

Preferably, a brightness value L* according to the CIELAB system at 45° of no more than 40 is desired in order to ensure that the primer coating is dark in color.

Preferably, a brightness value L* according to the CIELAB system at 45° of no more than 40 is achieved by incorporating the at least two kinds of pigments P-C1 and P-C2 in the amounts given hereinbefore into the primer coating composition.

### Constituents P-A1 and P-A2

The at least one film-forming polymer P-A1 functions as binder. For the purposes of the present invention, the term “binder” is understood in accordance with DIN EN ISO 4618 (German version, date: March 2007) to be the non-volatile constituent of a coating composition, which is responsible for the film formation. The term includes crosslinkers such as crosslinking agents P-A2 and additives if these represent non-volatile constituents. Pigments and/or fillers contained therein are thus not subsumed under the term “binder”. Preferably, the at least one polymer P-A1 is the main binder of the coating composition. As the main binder in the present invention, a binder component is preferably referred to, when there is no other binder component in the coating composition, which is present in a higher proportion based on the total weight of the coating composition.

The term “polymer” is known to the person skilled in the art and, for the purposes of the present invention, encompasses polyadducts and polymerizates as well as polycondensates. The term “polymer” includes both homopolymers and copolymers.

The at least one polymer used as constituent P-A1 may be self-crosslinking or non-self-crosslinking. Suitable polymers which can be used are, for example, known from EP 0 228 003 A1, DE 44 38 504 A1, EP 0 593 454 B1, DE 199 48 004 A1, EP 0 787 159 B1, DE 40 09 858 A1, DE 44 37 535 A1, WO 92/15405 A1 and WO 2005/021168 A1.

The at least one polymer used as constituent P-A1 is preferably selected from the group consisting of polyurethanes, polyureas, polyesters, polyamides, polyethers, poly(meth)acrylates and/or copolymers of the structural units of said polymers, in particular polyurethane-poly(meth)acrylates and/or polyurethane polyureas. The at least one polymer used as constituent P-A1 is particularly preferably selected from the group consisting of polyurethanes, polyesters, poly(meth)acrylates and/or copolymers of the structural units of said polymers. The term “(meth)acryl” or “(meth) acrylate” in the context of the present invention in each case comprises the meanings “methacrylic” and/or “acrylic” or “methacrylate” and/or “acrylate”.

Preferred polyurethanes are described, for example, in German patent application DE 199 48 004 A1, page 4, line 19 to page 11, line 29 (polyurethane prepolymer B1), in European patent application EP 0 228 003 A1, page 3, line 24 to page 5, Line 40, European Patent Application EP 0 634 431 A1, page 3, line 38 to page 8, line 9, and international patent application WO 92/15405, page 2, line 35 to page 10, line 32.

Preferred polyethers are, e.g., described in WO 2017/097642 A1 and WO 2017/121683 A1.

Preferred polyesters are described, for example, in DE 4009858 A1 in column 6, line 53 to column 7, line 61 and column 10, line 24 to column 13, line 3 or WO 2014/033135 A2, page 2, line 24 to page 7, line 10 and page 28, line 13 to page 29, line 13 described. Likewise preferred polyesters are polyesters having a dendritic structure or star-shaped structure, as described, for example, in WO 2008/148555 A1.

Preferred polyurethane-poly(meth)acrylate copolymers (e.g., (meth)acrylated polyurethanes)) and their preparation are described, for example, in WO 91/15528 A1, page 3, line 21 to page 20, line 33 and in DE 4437535 A1, page 2, line 27 to page 6, line 22 described.

Preferred (meth)acrylic copolymers are OH-functional. Hydroxyl-containing monomers include hydroxy alkyl esters of acrylic or methacrylic acid, which can be used for preparing the copolymer. Non-limiting examples of hydroxyl-functional monomers include hydroxyethyl(meth)acrylate, hydroxypropyl(meth)acrylates, hydroxybutyl-(meth)acrylates, hydroxyhexyl(meth)-acrylates, propylene glycol mono(meth)acrylate, 2,3-dihydroxypropyl(meth)acrylate, pentaerythritol mono(meth)acrylate, polypropylene glycol mono(meth)acrylates, polyethylene glycol mono(meth)acrylates, reaction products of these with epsilon-caprolactone, and other hydroxyalkyl-(meth)acrylates having branched or linear alkyl groups of up to about 10 carbons, and mixtures of these. Hydroxyl groups on a vinyl polymer such as an (meth)acrylic polymer can be generated by other means, such as, for example, the ring opening of a glycidyl group, for example from copolymerized glycidyl methacrylate, by an organic acid or an amine. Hydroxyl functionality may also be introduced through thio-alcohol compounds, including, without limitation, 3-mercapto-1-propanol, 3-mercapto-2-butanol, 11-mercapto-1-undecanol, 1-mercapto-2-propanol, 2-mercaptoethanol, 6-mercapto-1-hexanol, 2-mercaptobenzyl alcohol, 3-mercapto-1,2-proanediol, 4-mercapto-1-butanol, and combinations of these. Any of these methods may be used to prepare a useful hydroxyl-functional (meth)acrylic polymer. Examples of suitable comonomers that may be used include, without limitation, α,β-ethylenically unsaturated monocarboxylic acids containing 3 to 5 carbon atoms such as acrylic, methacrylic, and crotonic acids and the alkyl and cycloalkyl esters, nitriles, and amides of acrylic acid, methacrylic acid, and crotonic acid; α,β-ethylenically unsaturated dicarboxylic acids containing 4 to 6 carbon atoms and the anhydrides, monoesters, and diesters of those acids; vinyl esters, vinyl ethers, vinyl ketones, and aromatic or heterocyclic aliphatic vinyl compounds. Representative examples of suitable esters of acrylic, methacrylic, and crotonic acids include, without limitation, those esters from reaction with saturated aliphatic alcohols containing 1 to 20 carbon atoms, such as methyl, ethyl, propyl, isopropyl, n-butyl, isobutyl, tert-butyl, hexyl, 2-ethylhexyl, dodecyl, 3,3,5-trimethylhexyl, stearyl, lauryl, cyclohexyl, alkyl-substituted cyclohexyl, alkanol-substituted cyclohexyl, such as 2-tert-butyl and 4-tert-butyl cyclohexyl, 4-cyclohexyl-1-butyl, 2-tert-butyl cyclohexyl, 4-tert-butyl cyclohexyl, 3,3,5,5,-tetramethyl cyclohexyl, tetrahydrofurfuryl, and isobornyl acrylates, methacrylates, and crotonates; unsaturated dialkanoic acids and anhydrides such as fumaric, maleic, itaconic acids and anhydrides and their mono- and diesters with alcohols such as methanol, ethanol, propanol, isopropanol, butanol, isobutanol, and tert-butanol, like maleic anhydride, maleic acid dimethyl ester and maleic acid monohexyl ester; vinyl acetate, vinyl propionate, vinyl ethyl ether, and vinyl ethyl ketone; styrene, a-methyl styrene, vinyl toluene, 2-vinyl pyrrolidone, and p-tert-butylstyrene. The (meth)acrylic copolymer may be prepared using conventional techniques, such as by heating the monomers in the presence of a polymerization initiating agent and optionally a chain transfer agent.

Suitable poly(meth)acrylates are also those which can be prepared by multistage free-radical emulsion polymerization of olefinically unsaturated monomers in water and/or organic solvents. Examples of seed-core-shell polymers (SCS polymers) obtained in this manner are disclosed in WO 2016/116299 A1.

Preferred polyurethane-polyurea copolymers are polyurethane-polyurea particles, preferably those having a Z-average particle size of 40 to 2000 nm, the polyurethane-polyurea particles, each in reacted form, containing at least one isocyanate group-containing polyurethane prepolymer containing anionic and/or groups which can be converted into anionic groups and at least one polyamine containing two primary amino groups and one or two secondary amino groups. Preferably, such copolymers are used in the form of an aqueous dispersion. Such polymers can in principle be prepared by conventional polyaddition of, for example, polyisocyanates with polyols and polyamines.

The polymer used as constituent P-A1 preferably has reactive functional groups which enable a crosslinking reaction. Any common crosslinkable reactive functional group known to those skilled in the art can be present. Preferably, the polymer used as constituent P-A1 has at least one kind of functional reactive groups selected from the group consisting of primary amino groups, secondary amino groups, hydroxyl groups, thiol groups, carboxyl groups and carbamate groups. Preferably, the polymer used as constituent P-A1 has functional hydroxyl groups and/or carbamate groups.

Preferably, the polymer used as constituent P-A1 is hydroxyl-functional and more preferably has an OH number in the range of 15 to 400 mg KOH/g, more preferably from 20 to 250 mg KOH/g.

The polymer used as constituent P-A1 is particularly preferably a hydroxyl-functional polyurethane-poly (meth) acrylate copolymer, a hydroxyl-functional polyester and/or a hydroxyl-functional polyurethane-polyurea copolymer.

In addition, the primer coating composition may contain at least one typical crosslinking agent P-A2 known per se. Crosslinking agents are to be included among the film-forming non-volatile components of a coating composition, and therefore fall within the general definition of the “binder”.

All conventional crosslinking agents can be used. This includes melamine resins, preferably melamine aldehyde resins, more preferably melamine formaldehyde resins, blocked polyisocyanates, polyisocyanates having free (unblocked) isocyanate groups, crosslinking agents having amino groups such as secondary and/or primary amino groups, and crosslinking agents having epoxide groups and/or hydrazide groups, as well as crosslinking agents having carbodiimide groups, as long as the functional groups of the particular crosslinking agent are suitable to be reacted with the crosslinkable functional groups of the film-forming polymers used as binders in a crosslinking reaction. For example, a crosslinking agent having blocked or free isocyanate groups can be reacted with a film-forming polymer having crosslinkable OH-groups and/or amino groups at elevated temperatures in case of 1K formulations and at ambient temperature in case of 2K formulations.

If a crosslinking agent is present, it is preferably at least one aminoplast resin and/or at least one blocked or free polyisocyanate, preferably an aminoplast resin. Among the aminoplast resins, melamine resins such as melamine formaldehyde resins are particularly preferred. Preferably, the melamine aldehyde resins, preferably the melamine formaldehyde resins, in each case bear at least one of imino groups, alkykol groups and etherified alkylol groups as functional groups, which are reactive towards the functional groups of polymer P-A1. Examples of alkylol groups are methylol groups.

### Constituent(s) P-B

The primer coating composition comprises water and/or one or more organic solvents as constituent(s) P-B. This has been described hereinbefore in connection with the terms “aqueous” and “solventborne”.

### Constituent P-C

The pigment mixture P-C comprises at least two kinds of pigments being different from one another, namely at least one organic black or inorganic black pigment P-C1, which is not a carbon black pigment, and which is transparent or substantially transparent to NIR-radiation or which is reflective or substantially reflective to NIR-radiation, and at least one inorganic white pigment P-C2, which is reflective or substantially reflective to NIR-radiation. The term “NIR-radiation” has been defined hereinbefore and in particular covers a wavelength region from 800 nm to 2500 nm, such as from 850 to 2000 nm or such as from 900 nm to 1600 nm, most preferably at least a region of from 880 nm to 930 nm with 905 nm as center wavelength. It is, of course, possible that the primer coating composition comprises a pigment mixture P-C comprising in turn at least two pigments P-C1, one being transparent or substantially transparent to NIR-radiation, and one being reflective or substantially reflective to NIR-radiation, and at least one pigment P-C2. Preferably, the pigment P-C1 is transparent or substantially transparent to NIR-radiation. As the primer coating composition is free or essentially free of any metal effect pigment it is clear that none of the pigments present therein including the pigments in the pigment mixture P-C can be such a metal effect pigment.

Pigment P-C1 is transparent or substantially transparent to NIR-radiation or is reflective or substantially reflective to NIR-radiation, whereas pigment P-C2 is necessarily reflective or substantially reflective to NIR-radiation. The term “substantially” in connection with the term “substantially transparent” preferably means that the main part of the NIR radiation wavelength region, preferably of the region of 800 nm to 2500 nm, such as from 850 to 2000 nm or such as from 900 nm to 1600 nm, is transmitted by the respective pigment, more preferably at least 80% or 90% or 95% of the wavelength region. The term “substantially” in connection with the term “substantially reflective” preferably means that 25 to <100% of the NIR radiation wavelength region from 900 nm to 1600 nm is reflected by the respective pigment.

Pigment P-C1 is present in an amount in a range of from 0.1 to 20.0 wt.-%, preferably of from 0.2 to 15.0 wt.-%, more preferably of from 0.5 to 12.0 wt.-%, even more preferably of from 1.0 to 10.0 wt.-%, still more preferably of from 1.5 to 8.5 wt.-%, yet more preferably of from 2.0 to 7.0 wt.-%, based on the total weight of the primer coating composition, and pigment P-C2 is present in an amount in a range from 0.2 to 40.0 wt.-%, preferably of from 0.5 to 35.0 wt.-%, more preferably of from 1.0 to 30.0 wt.-%, even more preferably of from 2.0 to 25.0 wt.-%, still more preferably of from 4.0 to 20.0 wt.-%, yet more preferably of from 5.0 to 18.0 wt.-%, based on the total weight of the primer coating composition.

Preferably, the amount of pigment P-C2 in the primer coating composition exceeds the amount of pigment P-C1 C2 in the primer coating composition, preferably in that the relative weight ratio of pigment P-C2 to P-C1 is in a range of from 15:1 to 1.1:1, more preferably of from 12:1 to 1.5:1, even more preferably of from 10:1 to 2:1.

Preferably, the color of pigment P-C1 is characterized according to the CIELAB system at 45°, in that the L* value is less than 17, more preferred less than 15 and in that the a* and b* values are more than −4 and less than 9, more preferred less than 6 and most preferred less than 4 and preferably more than 0. Preferably, the color of pigment P-C2 is characterized according to the CIELAB system at 45°, in that the L* value is more than 85, preferably more than 90, the a* value is more than −2 and less than 2, preferably less than 0 and the b* value is less than 6 and preferably more than 0, more preferred more than 2 or 3.

Preferably,
the at least one black pigment P-C1 is a black pigment having a masstone color according to the CIELAB system at 45° with the values of L*<17, a*>−4 and <9, and b*>−4 and <9, preferably in that the at least one pigment P-C1 is selected from the group consisting of iron/chromium oxide compounds, manganese ferrite black oxide, calcium manganese titanium oxide, perylene pigments, azomethine pigments and mixtures thereof, in particular pigments nos. 31 and 32 (PBk 31 and PBk 32; CI names), more preferably is selected from perylene pigments, azomethine pigments and mixtures thereof, most preferably is selected from perylene pigments, and
the at least one white pigment P-C2 is a white pigment having a masstone color according to the CIELAB system at 45° with the values of L*>85, a*>−2 and <2, and b*>0 and <6, preferably is selected from the group consisting of titanium dioxide based or containing pigments, more preferably selected from titanium/aluminum/silicon oxide-based pigments and rod-like aluminum-doped titanium dioxide pigments. A rod-like pigment preferably has a long dimension of 1 to 5 such as 2 to 4 μm and a hart dimension of 0.2 to 0.6, such as 0.3 to 0.5 μm. Preferably, a rod-like pigment has an average D50 value, i.e., median particle size, in the range from 0.01 μm to 1 μm as determined by laser granulometry according to ISO 13320-1 (determined with a CILAS 1064 instrument).

The term “masstone color” or “masstone color with full hiding” is used and understood as it is commonly used and understood in colorimetry. The “masstone color” is defined as the color which is obtained by applying a coating layer containing the respective pigment to completely cover a black and a white substrate (typically a so-called “checker tile” being partially black and partially white is used) in a layer thickness, where no black and white color information shines through. The respective layer thickness is obtained by repeatedly spraying the coating composition until the colorimetric data for L*, a* and b* are the same for the coated black and white parts of the substrate, respectively, thus guaranteeing that no substrate color specific information confounds the pigment specific values. More details are disclosed in the method section of this invention. Thus, the term “masstone color” can be used to determine whether a certain pigment is a black pigment or is a white pigment in the sense of this term.

Commercially available pigments P-C2 are e.g. Tipaque Black SG103 (from Ishihara) and Paliogen® Black L0086 from BASF. Commercially available white pigments P-C2 are e.g., selected from Altiris 550 and Altiris 800 (both from Vanator), Tipaque PFR404 (from Ishihara), Ti-Pure® R-906 as well as Kronos® 2310.

The weight ratio of [(P-C1)+(P-C2)]/[(P-A1)+(P-A2)] in the primer coating composition is preferably in the range from 0.005 to 1.2, more preferred in the range from 0.01 to 1.0 and most preferred in the range from 0.015 to 0.75.

Preferably, the primer coating composition further comprises at least one preferably organic or inorganic, more preferably organic, coloring pigment P-C3, which is different from both pigments P-C1 and P-C2 and which is not a carbon black pigment, which is more preferably selected from blue, red and violet organic pigments.

### Second Layer L2 and Basecoat Composition

The second coating layer L2 of the multilayer coating system is applied over the first coating layer L1. The second coating layer L2 is formed from a basecoat composition different from the primer coating composition.

The term “basecoat” is known in the art and, for example, defined in Römpp Lexikon, paints and printing inks, Georg Thieme Verlag, 1998, 10th edition, page 57. A basecoat is therefore in particular used in automotive painting and general industrial paint coloring in order to give a coloring and/or an optical effect by using the basecoat as an intermediate coating composition.

The basecoat composition comprises as at least one constituent B-A at least one film-forming polymer B-A1, and in case of B-A1 being externally crosslinkable, at least one crosslinking agent B-A2, water and/or one or more organic solvents as constituent(s) B-B, and at least one metal effect pigment B-C1, which is a preferably platelet-shaped pearlescent or interference pigment, wherein the amount of the at least one pigment B-C1 in the basecoat composition exceeds the amount of any aluminum metal effect pigment(s) B-C2 optionally also present therein.

### Constituents B-A1 and B-A2

The same constituents described hereinbefore for use as P-A1 and P-A2 can also be used as constituents B-A1 and B-A2.

### Constituent(s) B-B

The basecoat composition comprises water and/or one or more organic solvents as constituent(s) B-B. This has been described hereinbefore in connection with the terms “aqueous” and “solventborne”.

### Constituent B-C1

The at least one pearlescent or interference pigment B-C1 is an effect pigment. A skilled person is familiar with the concept of the effect pigments. A corresponding definition is found for example in Römpp Lexikon, Lacke und Druckfarben, Georg Thieme Verlag, 1998, 10th edition, pages 176 and 471. A definition of pigments in general, and further particularizations thereof, are governed in DIN 55943 (date: October 2001). Effect pigments are preferably pigments which impart optical effect or both color and optical effect, especially optical effect. The terms “optical effect and color pigment”, “optical effect pigment” and “effect pigment” are therefore preferably interchangeable. Pigment B-C1 can be used to achieve a high flop index, optionally in combination with at least one additional pigment B-C2.

Preferably, pigment B-C1 is present in the form of flakes, more preferably in the form of non-opaque flakes. Preferably, pigment B-C1 is selected from mica pigments, which are coated with at least one kind of metal or semimetal oxide such as aluminum oxide and/or silica, glass pigments such as glass flakes having a silver reflection color, and metal oxide or semimetal oxide flakes coated with another metal oxide or semimetal oxide such as silica platelets coated with titanium dioxide. Examples of commercially available pigments for use as pigments B-C1 are e.g. Mearlin® Bright Silver 1303Z-Ext (mica platelet flakes coated with titanium dioxide and/or iron oxide), Iriodin® 9225 Rutile Blue Pearl SW (mica flakes) and Iriodin® 9605 Blue-Shade Silver SW (mica flakes). Other examples are Mearlin® Bright Silver 1303V and Iriodin® 9602 as well as Colorstream T20-04 Lapis Sunlight. An example of glass flakes having a silver reflection color is the product Lunan® CFX B001.

Preferably, pigment B-C1 has a D50 value, i.e., median particle size, in the range from 1 μm to 80 μm and even more preferred in the range from 5 μm to 35 μm as determined by laser granulometry according to ISO 13320-1 (determined with a CILAS 1064 instrument).

A pearlescent or interference pigment such as B-C1 is to be distinguished from metal effect pigments such as pigments B-C2.

The term “metal effect pigment” is used in accordance with EN ISO 18451-1:2019 (Pigments, dyestuffs and extenders—Terminology—Part 1). They are defined as platelet-shaped pigments consisting of metal such as aluminum. In the present invention the term “consisting of metal” does not exclude surface modifications of the metal effect pigments such as the presence of additional oxide layers, as e.g., a silicon dioxide layer. The term “metal” as used in the term “metal effect pigments” includes metals and metal alloys, likewise. Metal effect pigments—as already lined out above—can be orientated in parallel and show then metallic gloss due to light reflection at the flakes. Typical metals and alloys used in metal effect pigments are aluminum, and its alloys. Most suitable and preferred in the present invention as pigment B-C2 are platelet-shaped aluminum effect pigments, which might be coated or uncoated and which are preferably coated, particularly in case of the preferred aluminum pigments to inhibit their reaction with water in aqueous basecoat compositions. Such inhibition can e.g., be achieved by the use of organo-phosphorous stabilization; passivating the aluminum pigments with a conversion layer, e.g., by chromating; encapsulation with a protective layer, such as a polymer coating or a silica coating (Peter WiBling, “Metallic Effect Pigments”, Vincentz Network 2006, pp. 85-89). Such aluminum effect pigments are e.g., commercially available from ECKART GmbH (Germany) under the tradenames STAPA® Hydroxal (stabilized), STAPA® Hydrolux (chromated) and STAPA® Hydrolan (silica encapsulated). Further modification of the pigment surfaces is also possible, e.g., by modification with non-polar groups, such as alkyl groups leading to a so-called semi-leafing effect. The metal effect pigments B-C2, particularly aluminum effect pigments, may be coated with an oxide layer, such as a silica layer, which further helps to stabilize the pigments against mechanical impact und particularly improves circulation line stability. In the present invention silica encapsulated aluminum metal effect pigments are most preferred. Preferably, the amount of silica, based on the sum of the amounts of aluminum and silica in such preferred aluminum effect pigments ranges from 3 to 15 wt.-% more preferred from 5 to 12 wt.-% and most preferred from 6 to 10 wt.-%. However, the term “metal effect pigment” encompasses such coated pigments and the total weight of such coated metal effect pigment is understood to be the weight of the metal effect pigment. Thus, the weight includes the coating material.

Preferably, pigment B-C2 if present is present in the form of flakes, more preferably in the form of opaque flakes. Preferably, pigment B-C2 has a D50 value, i.e., median particle size, in the range from 5 μm to 100 μm and even more preferred in the range from 15 μm to 30 μm as determined by laser granulometry according to ISO 13320-1 (determined with a CILAS 1064 instrument).

Preferably, the relative weight ratio of the at least one preferably platelet-shaped pearlescent or interference pigment B-C1 to any one or more aluminum metal effect pigment(s) B-C2—if present in the basecoat composition—is in a range of from 15:1.0 to 1.1:1.0, preferably of from 12:1.0 to 1.2:1.0.

Preferably, the basecoat composition additionally optionally comprises at least one preferably platelet-shaped pearlescent or interference pigment B-C2, preferably in an amount in a range of from 0 to 10 wt.-% based on the total weight of the basecoat composition.

Preferably, the at least one preferably platelet-shaped pearlescent or interference pigment B-C1 is present in the basecoat composition in an amount in a range of from 1 to 50 wt.-%, more preferably of from 2 to 30 wt.-%, in each case based on the total weight of the basecoat composition.

The weight ratio of [(B-C1)+(B-C2)]/[(B-A1)+(B-A2)] in the basecoat composition is preferably in the range from 0.02 to 1.0, more preferred in the range from 0.05 to 0.5 and most preferred in the range from 0.1 to 0.35.

Preferably, the basecoat composition does not comprise any pigment, which is not a carbon black pigment or a pigment, which is absorptive to NIR radiation. The basecoat composition may comprise—besides B-C1 and optionally B-C2—at least one further pigment such as at least one pigment, which is transparent or substantially transparent to NIR-radiation or which is reflective or substantially reflective to NIR-radiation. Said at least one further pigment may be identical to or different from pigment P-C1 being present in the primer coating composition. Preferably, said at least one further pigment is selected from perylene pigments, azomethine pigments and mixtures thereof, in particular pigments nos. 31 and 32 (PBk 31 and PBk 32; CI names). Preferably, the amount of pigment B-C1 present in the basecoat composition exceeds the amount of the at least one further pigment.

### Third Coating Layer L3 and Topcoat Composition

The third top coating layer L3 of the multilayer coating system is applied over the second coating layer L2.

Preferably, the third coating layer L3 is formed from a coating composition, which is a clearcoat composition, preferably a solventborne clearcoat composition, wherein the third coating layer L3 is the outermost coating layer of the multilayer coating system.

Preferably, at least the second and the third coating layers L2 and L3 are positioned adjacently to each other, preferably also the first and the second coating layers L1 and L2 are positioned adjacently to each other. It is, however, also possible that at least layers L1 and L2 are not positioned adjacently to each other. Instead, a further coating layer L1a can be positioned between the first coating layer 11 and the second coating layer L2, wherein said further coating layer L1a preferably is formed from a coating composition comprising at least one organic black or inorganic black pigment, which is not a carbon black pigment, and which is transparent or substantially transparent to NIR-radiation, and which may be identical or different pigment P-C1. Said further coating composition is preferably different from all coating compositions used to form layers L1, L2 and L3. It has been found that the flop index of the multilayer coating system can be further improved/increased, when additional layer L1a is present between layers L1 and L2.

Preferably, the multilayer coating system is obtainable by a method, according to which at least the basecoat composition, which is used for preparing the second coating layer L2, and the coating composition used for preparing the third coating layer L3, which preferably is a clearcoat composition, are jointly cured to obtain the second and third coating layers L2 and L3 of the multilayer coating system. Preferably, the basecoat composition is applied into the already cured first coating layer L1 or onto an already cured coating layer L1a if present. Alternatively, the multilayer coating system may also be obtainable by a 3C1 B-method, wherein all coating compositions used to form coating layers L1, L2 and L3 are applied wet-on-wet-on-wet. In case additional layer L1a is also present, the multilayer coating system may also be obtainable by a 4C1 B-method, wherein all coating compositions used to form coating layers L1, l1a, L2 and L3 are applied wet-on-wet-on-wet.

### Method for Preparing the Multilayer Coating System

A further subject-matter of the present invention is a method for preparing the inventive multilayer coating system comprising at least steps (1), (2), (3) and (4), namely
(1) applying a primer coating composition to at least a portion of an optionally pre-coated substrate and forming a first coating film on at least a portion of the optionally pre-coated substrate,
(2) applying a basecoat composition different from the primer coating composition applied in step (1) to the first coating film present on the substrate obtained after step (1) and forming a second coating film, which preferably is adjacent to the first coating film,
(3) applying a coating composition different from the compositions applied in steps (1) and (2) to the second coating film present on the substrate obtained after step (2) and forming a third coating film, which is preferably adjacent to the second coating film, wherein said coating composition is preferably a clearcoat composition, and
(4) jointly curing at least the second and third coating films applied in steps (2) and (3) and optionally also the first coating film applied in step (1) in case said first coating film was not cured prior to performing of step (2) to obtain a multilayer coating system comprising at least the first, the second and the third coating layers L1, L2 and L3.

All preferred embodiments described hereinbefore in connection with the inventive multilayer coating system, and in each case the preferred embodiments thereof, are also preferred embodiments of the method for preparing the inventive multilayer coating system.

Curing is preferably selected from chemical curing such as chemical crosslinking, radiation curing, and/or physically drying (non-chemical curing), in each case at room temperature or at an elevated temperature, more preferably is selected from chemical curing such as chemical crosslinking, and/or physically drying (non-chemical curing), in each case at room temperature or at an elevated temperature. The curing temperature may vary from 80° C. to 160° C.

The method can comprise a further optional step (1a) performed between steps (1) and (2), namely
(1a) applying a coating composition different from the primer coating composition applied in step (1) to the first coating film present on the substrate obtained after step (1) and forming a further coating film, which preferably is adjacent to the first coating film,

Preferably, after an optional flash-off curing is performed after step (1a) to obtain a coating layer L1a being present over the first coating layer L1, preferably being adjacent to said coating layer L1, before step (2) is performed.

### Kit-of-Parts

A further subject-matter of the present invention is a kit-of-parts comprising in spatially separated form
as part (A), a primer coating composition as defined hereinbefore and hereinafter usable for preparing the first coating layer L1 of a multilayer coating system as defined as defined hereinbefore and hereinafter, and
as part (B), a basecoat composition as defined hereinbefore and hereinafter usable for preparing the second coating layer L2 of a multilayer coating system as defined hereinbefore and hereinafter, and
optionally as part (C), a clearcoat composition as defined hereinbefore and hereinafter usable for preparing the third coating layer L3 of a multilayer coating system as defined hereinbefore and hereinafter.

All preferred embodiments described hereinbefore in connection with the inventive multilayer coating system, the method for preparing the inventive multilayer coating system, and in each case the preferred embodiments thereof, are also preferred embodiments of the inventive kit-of-parts.

### Use

A further subject-matter of the present invention is a use of the kit-of-parts for improving, in particular for increasing, the LiDAR reflectivity, measured at an angle of incidence of 0°, and the flop index of multilayer coating systems, preferably of the multilayer coating system as defined hereinbefore and hereinafter, preferably for improving, in particular for increasing, the LiDAR reflectivity of multilayer coating systems, more preferably of the multilayer coating system as defined hereinbefore and hereinafter, to at least 10%, preferably to at least 15%, and the flop index of multilayer coating systems, more preferably of a multilayer coating system as defined hereinbefore and hereinafter to 8, preferably to ≥9, more preferably to 10, even more preferably to 12.

All preferred embodiments described hereinbefore in connection with the inventive multilayer coating system, the method for preparing the inventive multilayer coating system, the inventive kit-of-parts, and in each case the preferred embodiments thereof, are also preferred embodiments of the inventive use.

The inventive use allows a benefit from better infrared light and LiDAR visibility, in particular for autonomous systems such as self-driving vehicles and vehicles with ADAS.

### Methods

### 1. Determining the Non-Volatile Fraction

The amount of solid content (non-volatile matter, solid fraction) including the total solid content is determined via DIN EN ISO 3251:2019-09 at 110° C. for 60 min.

### 2. Measurement of Color Values

The L*a*b* color space or the L*a*b* color model (i.e. the CIELAB color model) is known to a person skilled in the art. The L*a*b* color model is standardized e.g., in DIN EN ISO/CIE 11664-4:2020-03. Each perceivable color in the L*a*b*-color space is described by a specific color location with the coordinates {L*,a*,b*} in a three-dimensional coordinate system. The a*-axis describes the green or red portion of a color, with negative values representing green and positive values representing red. The b*-axis describes the blue or yellow portion of a color, with negative values for blue and positive values for yellow. Lower numbers thus indicate a more bluish color. The L*-axis is perpendicular to this plane and represents the lightness (brightness). The color value L* is determined in accordance with ASTM E 284-81a. The values are measured by making use of the instrument BYK-mac i (BYK-Gardner) following ASTM D 2244, E308, E1164 and E2194. Analysis of the samples is done in accordance with color, sparkle and graininess measurement with the BYK-mac i spectrophotometer standard operating procedure. The samples to be analyzed are carefully wiped down with a microfiber cloth. The BYK-mac i instrument is then placed onto the substrate surface and performs a measurement using D65 light source at 15°, 45°, and 110° angles with data recorded for each angle. This measurement is taken on an individual panel in at least three different positions and values are averaged over the trials and reported.

### 3. Determination of LiDAR Reflectivity

LiDAR measurements at different angles were carried out using a Velodyne VLP-16 instrument (905 nm), measured at distance of 1 m. The instrument is calibrated using Permaflect 10%, 50% and 80% calibration tiles to give 10%, 50% and 80% reflection respectively at 0° AOI.

### 4. Determination of the Flop Index

The flop index was calculated according the following formula:

$$Flop index = \frac{2.69 {( {L}_{16 °}^{*} - {L}_{110 °}^{*} )}^{1.11}}{{( {L}_{45 °}^{*} )}^{0.86}}$$

The L*-values at different angles were measured according to the method described hereinbefore in item 2.

### 5. Determination of the Masstone Color of the Pigment(s) P-C1 and P-C2

The “masstone color” is determined as the color which is obtained by applying a coating layer containing the respective pigment to completely cover a black and a white substrate (typically a so-called “checker tile” being partially black and partially white is used) in a layer thickness, where no black and white color information shines through (full hiding). The coating composition used to determine the mass tone color for the aim of the present invention is described in the Table below. For each pigment P-C1 or P-C2, or for each mixture of pigments P-C1 or mixture of pigments P-C2, a piment paste is prepared by vibroshaking. The ingredients in each pigment paste were: 30 parts by weight of the respective solid pigment (i.e., pigment P-C1 or pigment P-C2 or mixture of pigments P-C1 or mixture of pigments P-C2, 15 parts by weight of water, 2 parts by weight of Butyl-Cellosolve, 39.2 parts by weight of a polyurethane grinding resin, 4.8 parts by weight of Pluracol 1010 Polyol and 9 parts by weight of Byk 184. The pigment paste was incorporated into the coating composition such that the pigment volume concentration is approx. 20%. The respective layer thickness is obtained by repeatedly spraying the coating composition until the colorimetric data for L*, a* and b* are the same for the coated black and white parts of the substrate, respectively, thus guaranteeing that no substrate color specific information confounds the pigment specific values. Typically, this is achieved at a coating thickness of about 20 μm.

TABLE
Coating composition used for determining the masstone color

| | | Basecoat |
|---|---|---|
| | | starting |
| | Ingredients | formulation |
| 1 | synthetic layered silicate thickening agent | 0.81 |
| | incorporating an inorganic polyphosphate peptiser | |
| 2 | propylene started polypropylene oxide (Mₙ ≈ 1,000) | 0.77 |
| 3 | tetramethyl decin diol (52 wt.-% in 2-butoxyethanol)/ | 0.66 |
| | wetting agent | |
| 4 | IPDI-based polyurethane (solids: 27 wt.-%); acid | 23.11 |
| | number 10 mg OH/g (A1) | |
| 5 | 2-ethylhexanol | 3.10 |
| 6 | polyester (solids: 60 wt.-%); acid number 32 mg | 0.39 |
| | KOH/g; M_{w} 21,000-36,000 (A1) | |
| 7 | highly alkylated, mixed ether (methyl/n-butyl) | 4.48 |
| | melamine crosslinker (solids: ≥97 wt.-%) (A2) | |
| 8 | Butyl-Cellosolve | 0.73 |
| 9 | dimethyl ethanolamine | 0.06 |
| 10 | TMXDI-based polyurethane (solids 35.5 wt.-%); | 6.66 |
| | hydroxyl number 109 mg OH/g; acid number 33.5 | |
| | mg OH/g (A1) | |
| 11 | ethylene glycol monobutyl ether | 1.39 |
| 12 | amine-neutralized p-toluenesulfonic acid catalyst | 0.78 |
| 13 | non-ionic medium pseudoplastic rheology modifying | 0.11 |
| | polyurethane emulsion (solids: 40 wt. % in | |
| | water/butyldiglycol) (A1) | |
| 14 | acrylic-copolymer thickener (solids: 30 wt.-% in | 0.31 |
| | water) | |
| 15 | water, deionized | 34.83 |

### Examples

The following examples further illustrate the invention but are not to be construed as limiting its scope. ‘Pbw’ means parts by weight. If not defined otherwise, ‘parts’ means ‘parts by weight’.

### 1. Preparation of Primer Coating Compositions

1.1 An inventively used primer coating composition P1I1 has been prepared by mixing the constituents listed in Table 1a in this order.

TABLE 1
Constituents of P1I1

| | Amount |
|---|---|
| Constituent | [pbw] |
| White pigment paste WP1 | 31.25 |
| Binder dispersion BD1 | 37.01 |
| Deionized water | 4.20 |
| Crosslinker dispersion CD1 | 20.03 |
| Deionized water | 8.96 |
| 2-Ethylhexanol | 2.04 |
| OS3 | 2.56 |
| OS2 | 2.04 |
| N,N′-Dimethylethanolamine | 0.001 |
| Ethylene glycol monobutyl ether | 0.001 |
| Deionized water | 6.72 |
| Black pigment paste BP2 | 60.71 |
| White pigment paste WP1 | 24.86 |
| Color pigment paste CP1 | 15.51 |
| Color pigment paste CP2 | 1.92 |

White pigment paste WP1 has a solid content of 63 wt.-% and contains 49 wt.-%, based on the total weight of WP1, of a commercial titanium dioxide white reflective pigment (Kronos® 2310). The binder dispersion BD1 contains an acrylic resin and has a solid content (resin solids) of 27 wt.-%. The crosslinker dispersion CD1 contains a crosslinker resin (Cymel® 203) as well as a polyester resin and has a total solid content (resin solids) of 55.54 wt.-%. OS2 is a mixture of organic solvents commercially available as Exxal® 13. OS3 is a mixture of organic solvents commercially available as Isopar®. Black pigment paste BP2 contains 18.5 wt.-%, based on its total weight, of Paliogen® L0086, a commercially available organic black pigment from BASF, which is a non-carbon black pigment. BP2 further contains 21 wt.-% polyacrylic resin solids, based on its total weight. Color pigment paste CP1 is a commercially available pigment paste (Hostaperm® Scarlet GO) containing a red pigment. CP1 contains 25 wt.-% pigment and 22 wt.-% of a polyurethane resin, in each case based on its total weight. Color pigment paste CP2 contains a phthalocyanine blue pigment. CP2 contains 27.47 wt.-% pigment and 17 wt.-% of a polyacrylic resin, in each case based on its total weight.

Primer P111 has a brightness L* of about 25 at 45°.

1.2 A commercially available comparatively used primer coating composition has been used as primer composition P1C1 (Dolomite Gray from BASF).

Primer P1C1 has a brightness L* of about 65 at 45°.

1.3 A commercially available comparatively used primer coating composition has been used as primer composition P1C2 (Alaska Gray from BASF).

Primer P1C2 has a brightness L* of about 18 at 45°.

### 2. Preparation of Basecoat Compositions

2.1 A basecoat starting formulation was prepared as shown in Table 2 below by mixing the constituents listed in Table 2 in this order.

TABLE 2a
Basecoat starting formulation

| | | Basecoat |
|---|---|---|
| | | starting |
| | Ingredients | formulation |
| 1 | synthetic layered silicate thickening agent | 0.81 |
| | incorporating an inorganic polyphosphate peptiser | |
| 2 | propylene started polypropylene oxide (Mₙ ≈ 1,000) | 0.77 |
| 3 | tetramethyl decin diol (52 wt.-% in 2-butoxyethanol)/ | 0.66 |
| | wetting agent | |
| 4 | IPDI-based polyurethane (solids: 27 wt.-%); acid | 23.11 |
| | number 10 mg OH/g (A1) | |
| 5 | 2-ethylhexanol | 3.10 |
| 6 | polyester (solids: 60 wt.-%); acid number 32 mg | 0.39 |
| | KOH/g; M_{w} 21,000-36,000 (A1) | |
| 7 | highly alkylated, mixed ether (methyl/n-butyl) | 4.48 |
| | melamine crosslinker (solids: ≥97 wt.-%) (A2) | |
| 8 | Butyl-Cellosolve | 0.73 |
| 9 | dimethyl ethanolamine | 0.06 |
| 10 | TMXDI-based polyurethane (solids 35.5 wt.-%); | 6.66 |
| | hydroxyl number 109 mg OH/g; acid number 33.5 | |
| | mg OH/g (A1) | |
| 11 | ethylene glycol monobutyl ether | 1.39 |
| 12 | amine-neutralized p-toluenesulfonic acid catalyst | 0.78 |
| 13 | non-ionic medium pseudoplastic rheology modifying | 0.11 |
| | polyurethane emulsion (solids: 40 wt. % in | |
| | water/butyldiglycol) (A1) | |
| 14 | acrylic-copolymer thickener (solids: 30 wt.-% in | 0.31 |
| | water) | |
| 15 | water, deionized | 34.83 |

2.2 Different kinds of pigments were added to the basecoat starting formulation in order to obtain a number of different basecoat compositions.

The following commercially available pigments have been used:
Pigment 1 (Pi1): STAPA® Hydrolan 2153 (aluminum flake pigment)
Pigment 2 (Pi2): Mearlin® Bright Silver 1303Z-Ext (mica platelet flakes coated with titanium dioxide and/or iron oxide)
Pigment 3 (Pi3): STAPA® Hydrolan 9160 (aluminum flake pigment)
Pigment 4 (Pi4): Iriodin® 9225 Rutile Blue Pearl SW (mica flakes)
Pigment 5 (Pi5): STAPA® Hydrolan 2197 (aluminum flake pigment)
Pigment 6 (Pi6): Iriodin® 9605 Blue-Shade Silver SW (mica flakes).

A total of five different basecoats have been obtained in this manner (BC1 to BC5). In Table 2b it is summarized, what kind of pigments are present therein. P/B means pigment/binder resins ratio.

TABLE 2b
Basecoats

| | | Pigment flakes in |
|---|---|---|
| | | basecoat |
| Basecoat | P/B | (weight ratio) |
| BC1 | 0.18 | Pi1 |
| BC2 | 0.10 | Pi2 |
| BC3 | 0.166 | Pi3:Pi4:Pi5 |
| | | (46.45:6.54:15.48) |
| BC4 | 0.20 | Pi6:Pi2:Pi1 |
| | | (2.98:67.91:18.92) |

### 3. Preparation of Multilayer Coating Systems

On a pre-treated steel-panel coated with a cathodic electrodeposition coating layer using Cathoguard 800, a primer layer made from one of P1C1, P1C2 or P111 is formed and cured for 25 minutes at about 140° C. (about 20 to 23 μm dry film thickness). Then, one of basecoat compositions BC1, BC2, BC3, BC4 or BC5 is applied onto the cured primer film and flashed off for 7 minutes at about 60° C. Then, a clearcoat composition is applied onto the flashed off basecoat film. The two films are then jointly cured at about 140° C. for 25 minutes (about 20 to 23 μm dry basecoat film thickness and about 50 μm dry clearcoat film thickness). A commercial clearcoat product (ProGloss/2K4) was used. All compositions were applied by pneumatic spraying. The clearcoat layer is a transparent layer and is also transparent to IR radiation. The obtained multilayer coating systems (MLCS) are then investigated. The properties indicated in the Table 3 were measured as described hereinbefore in the ‘methods’ section.

TABLE 3
Comparison of LiDAR and Flop index for different multilayer
coating systems with different silver shades

| | | | | LiDAR |
|---|---|---|---|---|
| | | | | reflectivity |
| | | | | 905 nm, 45° |
| | Basecoat | Primer | Flop | AOI (angle of |
| | applied | applied | Index | incidence) |
| Comparative | BC1 | P1C1 | 13.8 | 3.65 |
| example 1 (CE1) | | | | |
| Example 1 (E1) | BC2 | P1I1 | 14.0 | 37.12 |
| Comparative | BC3 | P1C1 | 6.0 | 8 |
| example 2A | | | | |
| (CE2A) | | | | |
| Comparative | BC3 | P1C2 | 6.0 | 8 |
| example 2B | | | | |
| (CE2B) | | | | |
| Example 2 (E2) | BC4 | P1I1 | 15.6 | 15.67 |

Both CE1 and E1 have similar silver flop indices, but the multilayer coating system of E1 has much higher LiDAR reflectivity. The primers used in the systems in both examples are LiDAR active. For aluminum flake pigments such as Pi1 as present in BC1, being an opaque metal, the reflection is totally independent of the primer system used. This can be seen in one of the silver colors in CE2A and CE21B, wherein basecoat BC3 used in both cases contains mica flakes (Pi4) only in small quantities (<10 wt.-%). As can be seen in case of E2, a multilayer coating system made by using primer Pill and a mica flakes-based basecoat BC4 provides not only high flop, but also good LiDAR reflectivity. A conventional bright primer (P1C1) may provide good LiDAR reflectivity, but only poor coloristics, whereas a conventional dark primer (P1 C2) may provide a good flop index, but only poor LiDAR reflectivity.

These results demonstrate that only with the inventive multilayer coating system made by using a non-opaque flakes-based basecoat such as BC2, BC4 or BC5 in combination with a dark primer such as P1I1 (L*≤40) a unique silver color can be provided, which not only has a high flop index, but also a high LiDAR reflectivity at off-specular angle.

1. A multilayer coating system being present on an optionally pre-coated substrate and comprising at least three coatings layers L1, L2 and L3 being different from one another, namely
a first coating layer L1 applied over at least a portion of an optionally pre-coated substrate,
a second coating layer L2 applied over the first coating layer L1, and
a third top coating layer L3 applied over the second coating layer L2,
wherein the first coating layer L1 is formed from a primer coating composition and the second coating layer L2 is formed from a basecoat composition different from the primer coating composition,
wherein
the primer coating composition comprises as at least one constituent P-A at least one film-forming polymer P-A1, and in case of P-A1 being externally crosslinkable, at least one crosslinking agent P-A2, water and/or one or more organic solvents as constituent(s) P-B, and is free of or essentially free of metal effect pigments, but comprises pigment mixture as at least one constituent P-C comprising at least two kinds of pigments being different from one another, namely at least one organic black or inorganic black pigment P-C1, which is not a carbon black pigment, and which is transparent or substantially transparent to NIR-radiation or which is reflective or substantially reflective to NIR-radiation, and at least one inorganic white pigment P-C2, which is reflective or substantially reflective to NIR-radiation,
wherein pigment P-C1 is present in the primer coating composition in an amount in a range of from 0.1 to 20.0 wt.-%, based on the total weight of the primer coating composition, and pigment P-C2 is present in the primer coating composition in an amount in a range from 0.2 to 40.0 wt.-%, based on the total weight of the primer coating composition, and the basecoat composition comprises as at least one constituent B-A at least one film-forming polymer B-A1, and in case of B-A1 being externally crosslinkable, at least one crosslinking agent B-A2, water and/or one or more organic solvents as constituent(s) B-B, and at least one effect pigment B-C1, which is a pearlescent or interference pigment, wherein the amount of the at least one pigment B-C1 in the basecoat composition exceeds the amount of any aluminum metal effect pigment(s) B-C2 optionally also present therein.

2. The multilayer coating system according to claim 1, wherein the first coating layer L1 formed from the primer coating composition and applied over at least a portion of the optionally pre-coated substrate has a brightness value L* according to the CIELAB system at 450 of no more than 40, and/or has a LiDAR reflectivity, measured at an angle of incidence of 0°, of at least 40%.

3. The multilayer coating system according claim 1, wherein the amount of pigment P-C2 in the primer coating composition exceeds the amount of pigment P-C1 C2 in the primer coating composition.

4. The multilayer coating system according to claim 1, wherein
the at least one black pigment P-C1 is a black pigment having a masstone color according to the CIELAB system at 45° with the values of L*<17, a*>−4 and <9, and b*>−4 and <9, and
the at least one white pigment P-C2 is a white pigment having a masstone color according to the CIELAB system at 450 with the values of L*>85, a*>−2 and <2, and b*>0 and <6.

5. The multilayer coating system according to claim 1, wherein the relative weight ratio of the at least one pearlescent or interference pigment B-C1 to any one or more aluminum metal effect pigment(s) B-C2—if present in the basecoat composition—is in a range of from 15:1.0 to 1.1:1.0.

6. The multilayer coating system according to claim 1, wherein the basecoat composition additionally comprises at least one aluminum metal effect pigment B-C2.

7. The multilayer coating system according to claim 1, wherein the at least one preferably pearlescent or interference pigment B-C1 is present in the basecoat composition in an amount in a range of from 1 to 15 wt.-% based on the total weight of the basecoat composition.

8. The multilayer coating system according to claim 1, wherein both the primer coating composition used to form the first coating layer L1 and the basecoat composition used to form the second coating layer L2 are free or essentially free of any carbon black.

9. The multilayer coating system according to claim 1, wherein the multilayer coating system has a LiDAR reflectivity, measured at an angle of incidence of 45°, of at least 10%, and the multilayer coating system has a flop index of ≥8.

10. The multilayer coating system according to claim 1, wherein the third coating layer L3 is formed from a coating composition, which is a clearcoat composition, wherein the third coating layer L3 is the outermost coating layer of the multilayer coating system.

11. The multilayer coating system according to claim 1, wherein at least the second and the third coating layers L2 and L3 are positioned adjacently to each other, or wherein a further coating layer L1a is positioned between the first coating layer L1 and the second coating layer L2.

12. The multilayer coating system according to claim 1, wherein it is obtained by a method, according to which at least the basecoat composition, which is used for preparing the second coating layer L2, and the coating composition used for preparing the third coating layer L3, are jointly cured to obtain the second and third coating layers L2 and L3 of the multilayer coating system.

13. A method for preparing the multilayer coating system according to claim 1, comprising at least steps (1), (2), (3) and (4), namely
(1) applying a primer coating composition to at least a portion of an optionally pre-coated substrate and forming a first coating film on at least a portion of the optionally pre-coated substrate,
(2) applying a basecoat composition different from the primer coating composition applied in step (1) to the first coating film present on the substrate obtained after step (1) and forming a second coating film,
(3) applying a coating composition different from the compositions applied in steps (1) and (2) to the second coating film present on the substrate obtained after step (2) and forming a third coating film, and
(4) jointly curing at least the second and third coating films applied in steps (2) and (3) and optionally also the first coating film applied in step (1) in case said first coating film was not cured prior to performing of step (2) to obtain a multilayer coating system comprising at least the first, the second and the third coating layers L1, L2 and L3.

14. A kit-of-parts comprising in spatially separated form
as part (A), a primer coating composition used for preparing the first coating layer L1 of the multilayer coating system of claim 1, and
as part (B), a basecoat composition used for preparing the second coating layer L2 of the multilayer coating system, and
optionally as part (C), a clearcoat composition used for preparing the third coating layer L3 of the multilayer coating system.

15. A of method of using the kit-of-parts of according to claim 14, the method comprising using the kit-of-parts for improving the LiDAR reflectivity, measured at an angle of incidence of 0°, and the flop index of multilayer coating systems.

16. The multilayer coating system according to claim 1, wherein the first coating layer L1 formed from the primer coating composition and applied over at least a portion of the optionally pre-coated substrate has a brightness value L* according to the CIELAB system at 450 of no more than 38, and/or has a LiDAR reflectivity, measured at an angle of incidence of 0°, of at least 45%.

17. The multilayer coating system according claim 1, wherein the amount of pigment P-C2 in the primer coating composition exceeds the amount of pigment P-C1 C2 in that the relative weight ratio of pigment P-C2 to P-C1 is in a range of from 15:1 to 1.1:1.

18. The multilayer coating system according to claim 4, wherein
the at least one pigment P-C1 is selected from the group consisting of iron/chromium oxide compounds, manganese ferrite black oxide, calcium manganese titanium oxide, perylene pigments, azomethine pigments and mixtures thereof, and
the at least one white pigment P-C2 is selected from the group consisting of titanium dioxide based or containing pigments.

19. The multilayer coating system according to claim 1, wherein the relative weight ratio of the at least one platelet-shaped pearlescent or interference pigment B-C1 to any one or more aluminum metal effect pigment(s) B-C2—if present in the basecoat composition—is in a range of from 12:1.0 to 1.2:1.0.

20. The multilayer coating system according to claim 1, wherein the third coating layer L3 is formed from a coating composition, which is a solventborne clearcoat composition, wherein the third coating layer L3 is the outermost coating layer of the multilayer coating system.
